(19) United States
(12) Patent Application Publication
(10) Pub. No.: US 2008/0028117 A1
(43) Pub. Date: Jan. 31, 2008

(54) Method and Apparatus for Notifying User About Non-Optimal Hot-Add Memory Configurations

(75) Inventors: Vijay Nijhawan, Austin, TX (US); Madhusudhan Rangarajan, Round Rock, TX (US); Wuxian Wu, Round Rock, TX (US)

Correspondence Address: BAKER BOTTS, LLP, 910 LOUISIANA, HOUSTON, TX, 77002-4995, US

(73) Assignee: Dell Products L.P.

(21) Appl. No.: 11/460,056

(22) Filed: Jul. 26, 2006

(51) Int. Cl. G06F 13/00

(52) U.S. Cl. 710/302; 713/2

(57) ABSTRACT

During power-on self-test (POST) the basic input-output operating system (BIOS) may set hot-add status light emitting diodes (LEDs) to appropriate colors so as to indicate which memory slot(s) is most optimal for hot-adding a hot-plug memory module. In the case where the user or administrator fails to notice or understand the meaning of the LED color representation when hot-adding the new memory module, the BIOS Service Management Initiative (SMI) handler (which controls the hot-add to the information handling system) will verify if the hot-add memory module is being installed into an optimal memory slot. If not, the BIOS may capture a Chassis System Event Log (SEL) indicating a non-optimal Hot-add and may flash a front panel LED to a certain color, e.g., amber, and may also issue an appropriate error message. Additional Advanced Configuration and Power Interface (ACPI) implementations may be used for a more user-friendly alert and/or message display.

### TECHNICAL FIELD

The present disclosure relates generally to information handling systems and, more particularly, to optimizing memory/processor performance in information handling systems having non-uniform memory access (NUMA) architecture.

### BACKGROUND

As the value and use of information continues to increase, individuals and businesses seek additional ways to process and store information. One option available to users are information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems, e.g., computer, personal computer workstation, portable computer, computer server, print server, network router, network hub, network switch, storage area network disk array, RAID disk system and telecommunications switch.

Information handling systems having tightly coupled multiprocessors and non-uniform memory access (NUMA) architecture may provide overall speed advantages not possible with common shared memory multiprocessor information handling systems. The NUMA architecture provides overall speed advantages over the common shared memory multiprocessor information handling systems. The NUMA architecture can combine massive scalability of hundreds of processors with the simplified programming model of multiprocessor technology. Generally speaking, a NUMA computer system is a set of multiprocessor nodes interconnected with a high bandwidth interconnection that allows all processors to access any of the main memory within the NUMA computer system. Each processor node shares the same addressable main memory storage, which is distributed among the local memory of all the processor nodes. The access time to the local memory within a processor node is the same for all processors within the processor node. Access to a memory on another processor node, however, has a much greater access latency time than a similar access to a local memory. Thus for fastest system operation, it is best to maintain computation of a process on the same node. It is also preferable to have the largest memory on the processor node(s) having the fastest operating speeds.

### SUMMARY

In the NUMA systems, memory is local to each processor(s) (node) present in the information handling system, with a built-in memory controller in each processor (e.g., central processing unit—“CPU”). When features such as hot-add are supported in a NUMA information handling system, it is desirable to notify a user or administrator of the location(s) of a memory slot(s) to install memory that will result in optimal performance of the information handling system.

What is needed is a simple and inexpensive way to indicate which memory slot(s) in a processor node(s) will result in the fastest memory/processor operation when adding memory in a NUMA information handling system. Fastest operation may result by using CPUs having the fastest clocks in a node and/or the node(s) having the fastest memory access in reads and writes between the memory and the processor(s). For example referring to FIG. 1, when memory slots associated with CPU0 and CPU2 are free, and CPU0 operates at 4 GHz and CPU2 operates at 3 GHz, installation of new hot-add memory at the CPU0 local memory slots would provide the best system performance. Also nodes having enhanced memory controller capabilities for supporting the latest and fastest memory would result in better performance from the faster memories. In addition, various other factors such as interconnection speed, bandwidth, etc., may also be factors in maximizing system performance.

According to the teachings of this disclosure, during power-on self-test (POST) the basic input-output operating system (BIOS) may set hot-add status light emitting diodes (LEDs) to appropriate colors so as to indicate which memory slot(s) is most optimal for hot-adding a hot-plug memory module. In the case where the user or administrator fails to notice or understand the meaning of the LED color representation when hot-adding the new memory module, or in implementations where no LEDs exist, the BIOS Service Management Initiative (SMI) handler (which controls the hot-add to the information handling system) may verify if the hot-add memory module is being installed into an optimal memory slot. If not, the BIOS may capture a Chassis System Event Log (SEL) indicating a non-optimal Hot-add and may flash a front panel LED to a certain color, e.g., amber, and may also issue an appropriate error message. Additional Advanced Configuration and Power Interface (ACPI) implementations may be used for a more user-friendly alert and/or message display.

According to a specific example embodiment of this disclosure, a method for notifying user about non-optimal hot-add memory configurations may comprise the steps of: discovering and configuring memory in an information handling system during a basic input-output system (BIOS) power-on self-test (POST) of the information handling system; setting light emitting diodes (LEDs) to a first color that are associated with occupied memory slots; setting LEDs to a second color that are associated with unoccupied memory slots coupled to slower central processing units (CPUs); and setting LEDs to a third color that are associated with unoccupied memory slots coupled to faster CPUs. The color of the first LEDs may be red, the color of the second LEDs may be yellow, and the color of the third LEDs may be green.

According to another specific example embodiment of this disclosure, a method for notifying user about insertion of a hot-add memory module into a non-optimal hot-add memory slot may comprise the steps of: a) starting a basic input-output system (BIOS) hot-add handler; b) determining whether a hot-add memory module was added to an optimal or non-optimal hot-add memory slot, wherein b1) if the hot-add memory module was added to an optimal hot-add memory slot then completing the hot-add memory module operation, notifying an operating system of the completion of the hot-add memory module operation, and then going to step c); b2) if the hot-add memory module was added to a non-optimal hot-add memory slot then logging an event indicating that a non-optimal hot-add was attempted, displaying an error message that the non-optimal hot-add was attempted, and then going to step c); c) ending the BIOS hot-add handler.

According to yet another specific example embodiment of this disclosure, an apparatus for notifying user about non-optimal hot-add memory configurations, may comprise: first light emitting diodes (LEDs) associated with occupied memory slots, wherein the first LEDs are set to a first color; second LEDs associated with unoccupied memory slots coupled to slower central processing units (CPUs), wherein the second LEDs are set to a second color; and third LEDs associated with unoccupied memory slots coupled to faster CPUs, wherein the third LEDs are set to a third color. The color of the first LEDs may be red, the color of the second LEDs may be yellow, and the color of the third LEDs may be green.

### BRIEF DESCRIPTION OF THE DRAWINGS

A more complete understanding of the present disclosure thereof may be acquired by referring to the following description taken in conjunction with the accompanying drawings wherein:

FIG. 1 is a schematic block diagram of a NUMA information handling system, according to a specific example embodiment of the present disclosure;

FIG. 2 is a schematic flow diagram of a BIOS flow in POST, according to a specific example embodiment of the present disclosure; and

FIG. 3 is a schematic flow diagram of a BIOS Hot-add SMI, according to a specific example embodiment of the present disclosure.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU), hardware or software control logic, read only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring now to the drawings, the details of specific example embodiments are schematically illustrated. Like elements in the drawings will be represented by like numbers, and similar elements will be represented by like numbers with a different lower case letter suffix.

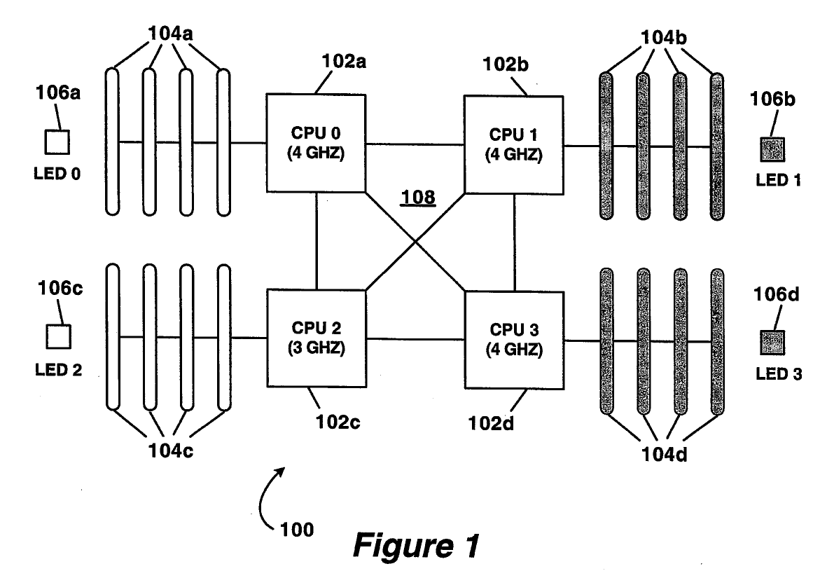

Referring to FIG. 1, depicted is a schematic block diagram of a NUMA information handling system, according to a specific example embodiment of the present disclosure. The NUMA information handling system, generally represented by the numeral 100, may comprise a plurality of central processing units (CPUs) 102, a plurality of memory slots 104 and a plurality of light emitting diodes (LEDs) 106. Each one of the plurality of CPUs 102 may be closely coupled to respective ones of the plurality of memory slots 104 e.g. CPU 102a is closely coupled to the memory slots 104a, CPU 102b is closely coupled to the memory slots 104b, CPU 102c is closely coupled to the memory slots 104c, and CPU 102d is closely coupled to the memory slots 104d. Each one of the plurality of LEDs 106 is associated with a respective one of the plurality of CPUs 102. The plurality of CPUs 102 are coupled together over high speed data buses, generally represented by the numeral 108.

According to the teaching of this disclosure, for example, memory slots 104b and 104d may be filled with memory modules (not shown) and may result in the associated LEDs 106b and 106d being red. Memory slots 104c may be empty and the associated LED 104c may be amber, indicating non-optimal memory slots because the associated CPU 102c is lower than the other CPUs 102 in the information handling system 100. Memory slots 104a may be empty and the associated LED 104a may be green, indicating optimal memory slots for adding hot-add memory modules (not shown) to the information handling system. A user or technician/administrator now may easily spot which ones of the memory slots 104 are best to insert the memory modules for optimal performance of the information handling system 100.

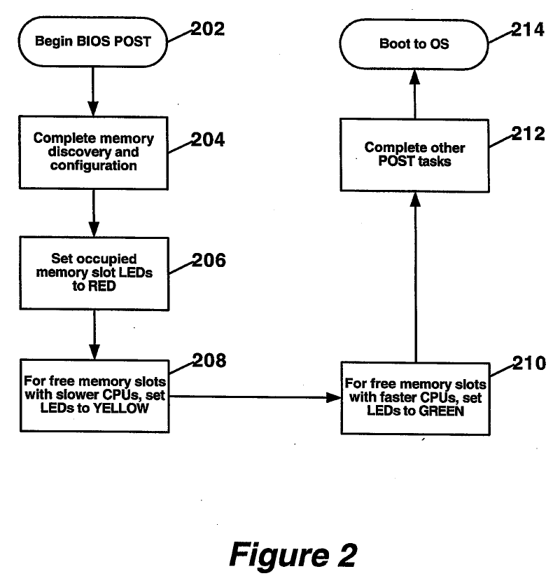

Referring to FIG. 2, depicted is a schematic flow diagram of a BIOS flow in POST, according to a specific example embodiment of the present disclosure. In step 202, the BIOS POST begins. In step 204, memory discovery and configuration are completed. In step 206, all LEDs 106 associated with filed memory slots 104 are set to red. In step 208, all LEDs 106 associated with free memory slots 104 and the slower CPUs 102 are set to yellow. In step 210, all LEDs 106 associated with free memory slots 104 and the faster CPUs 102 are set to green. In step 212, the remainder of the POST tasks are completed, and in step 214 the BIOS boots up the main operating system of the information handling system 100.

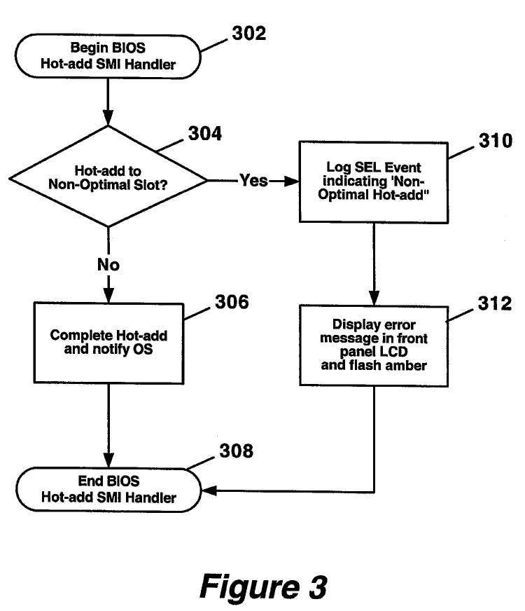

Referring to FIG. 3, depicted is a schematic flow diagram of a BIOS Hot-add SMI, according to a specific example embodiment of the present disclosure. In step 302, a Hot-add SMI handler is started. In step 304, a determination is made of whether the Hot-add memory was added to a non-optimal memory slot 104. If the Hot-add memory was added to an optimal memory slot 104, then in step 306 the Hot-add operation is completed and the information handling system 100 operating system is notified of a successful Hot-add event. Then in step 308, the BIOS may end the Hot-add SMI handler.

However, If the Hot-add memory was added to a non-optimal memory slot 104, then in step 310 a Chassis System Event Log (SEL) may indicate to the user or administrator that a non-optimal Hot-add was attempted. In step 312, an error message indicating that a Hot-add was attempted to a non-optimal memory slot 104, e.g., to a front panel LCD and/or a front panel indicator may flash a selected color, e.g., amber. These alarms and messages may alert the user or administrator of the incorrect use of a non-optimal memory slot(s) 104 so that the error may be corrected and the Hot-add memory module(s) may be added to an optimal memory slot(s) 104. Then in step 308, the BIOS may end the Hot-add SMI handler.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. A method for notifying user about non-optimal hot-add memory configurations, said method comprising the steps of:
discovering and configuring memory in an information handling system during a basic input-output system (BIOS) power-on self-test (POST) of the information handling system;
setting light emitting diodes (LEDs) to a first color that are associated with occupied memory slots;
setting LEDs to a second color that are associated with unoccupied memory slots coupled to slower central processing units (CPUs); and
setting LEDs to a third color that are associated with unoccupied memory slots coupled to faster CPUs.

2. The method according to claim 1, wherein the information handling system has a non-uniform memory access (NUMA) architecture.

3. The method according to claim 1, wherein the first color is red.

4. The method according to claim 1, wherein the second color is yellow.

5. The method according to claim 1, wherein the third color is green.

6. A method for notifying user about insertion of a hot-add memory module into a non-optimal hot-add memory slot, said method comprising the steps of:
a) starting a basic input-output system (BIOS) hot-add handler;
b) determining whether a hot-add memory module was added to an optimal or non-optimal hot-add memory slot, wherein
b1) if the hot-add memory module was added to an optimal hot-add memory slot then completing the hot-add memory module operation, notifying an operating system of the completion of the hot-add memory module operation, and then going to step c);
b2) if the hot-add memory module was added to a non-optimal hot-add memory slot then logging an event indicating that a non-optimal hot-add was attempted, displaying an error message that the non-optimal hot-add was attempted, and then going to step c);
c) ending the BIOS hot-add handler.

7. The method according to claim 6, wherein the step of starting a hot-add handler comprises the step of starting a hot-add Service Management Initiative (SMI) handler.

8. The method according to claim 6, wherein the step of logging the event comprises the step of logging a chassis system event log (SEL).

9. The method according to claim 6, wherein the error message is displayed as a flashing light.

10. The method according to claim 9, wherein the flashing light color is amber.

11. The method according to claim 6, wherein the error message is displayed on a front panel display.

12. The method according to claim 11, wherein the front panel display is a liquid crystal display.

13. An apparatus for notifying user about non-optimal hot-add memory configurations, comprising:
first light emitting diodes (LEDs) associated with occupied memory slots, wherein the first LEDs are set to a first color;
second LEDs associated with unoccupied memory slots coupled to slower central processing units (CPUs), wherein the second LEDs are set to a second color; and
third LEDs associated with unoccupied memory slots coupled to faster CPUs, wherein the third LEDs are set to a third color.

14. The apparatus according to claim 13, further comprising an information handling system having a non-uniform memory access (NUMA) architecture.

15. The apparatus according to claim 13, wherein the first color is red.

16. The apparatus according to claim 13, wherein the second color is yellow.

17. The apparatus according to claim 13, wherein the third color is green.
